(19) United States
(12) Patent Application Publication
(10) Pub. No.: US 2017/0036190 A1
(43) Pub. Date: Feb. 9, 2017

(54) SUPERHYDROPHOBIC SPONGE AS AN EFFICIENT OIL ABSORBENT MATERIAL FOR OIL SPILL CLEANUP APPLICATIONS

(71) Applicant: BROOKHAVEN SCIENCE ASSOCIATES, LLC, UPTON, NY (US)

(72) Inventors: VIET HUNG PHAM, WARD 10 (VN); JAMES HENRY DICKERSON, PROVIDENCE, RI (US)

(73) Assignee: BROOKHAVEN SCIENCE ASSOCIATES, LLC, UPTON, NY (US)

(21) Appl. No.: 15/304,021

(22) PCT Filed: Apr. 15, 2015
(86) PCT No.: PCT/US2015/025872

§ 371 Date: Oct. 13, 2016

Related U.S. Application Data
(60) Provisional application No. 61/979,801, filed on Apr. 15, 2014.

(51) Int. Cl. B01J 20/26; B01J 20/32; C02F 1/68; C02F 1/28; C02F 1/40; B01J 20/28; C09K 3/32

(52) U.S. Cl. CPC B01J 20/265; B01J 20/28045; B01J 20/3212; B01J 20/3219; B01J 20/3278; C09K 3/32; C02F 1/285; C02F 1/40; C02F 1/681; C02F 2101/32

(57) ABSTRACT

This disclosure describes hydrophobic or super-hydrophobic compositions, such as sponges, that also are oleophilic or super-oleophilic with superior recyclability, good mechanical strength, low cost, and manufacture scalability. The hydrophobic or super-hydrophobic compositions include the reaction product of at least a substrate having a reacting group which reacts with a silane and an alkylsilane or a fluoroalkylsilane having an alkyl group comprised of a hydrocarbon, an aliphatic hydrocarbon, or a fluorohydrocarbon of 1 to about 30 carbon atoms.

This application claims the benefit under 35 U.S.C. 119(e) of U.S. Provisional Application No. 61/979,801 filed on Apr. 15, 2014, the disclosure of which is incorporated herein in its entirety.

This invention was made with Government support under contract number DE-AC02-98CH10886 and DE-SC0012704 awarded by the U.S. Department of Energy. The Government has certain rights in the invention.

### I. FIELD OF THE INVENTION

This disclosure relates generally to hydrophobic or super-hydrophobic compositions that may also be oleophilic or super-oleophilic. In particular, it relates to hydrophobic or super-hydrophobic compositions for use as oil absorbent materials.

### II. BACKGROUND

Cleaning up oil spills and oil slicks from the surfaces of water and along the coastline, among other areas, is a challenging task. Several methods have been used to clean up such calamities, including in-situ burning, chemical dispersant, skimming, bioremediation, and using sorbents. Skimming involves time consuming procedures for remediation, high expense, and poor segregation of oil and water. Chemical dispersants break up oil deposits into droplets, which are easily dissipated within a water column. However, this method can cause additional damage to marine ecosystems due to the synergistic toxicity of the mixture of oil and the employed dispersants. The use of oil sorbents has been considered one of the more effective approaches for oil spill cleaning due to its propensity for oil collection and separation from the present water. Oil sorbents generally are able to concentrate and transform liquid oil into a semi-solid or solid phase, which can then be removed from the spill area in a convenient manner. Superhydrophobic sponges and sponge-like materials have recently attracted great attention as potential sorbent material for oil spill cleanup due to their excellent sorption capacity and its high selectivity. A challenge is the fabrication of a superhydrophobic sponge with superior recyclability, good mechanical strength, low cost, and manufacture scalability.

### SUMMARY

This disclosure provides embodiments of superhydrophobic sponges with superior recyclability, good mechanical strength, low cost, and manufacture scalability.

In an embodiment, a hydrophobic or superhydrophobic composition is provided which includes the reaction product of at least a substrate having a reacting group which reacts with a silane and an alkylsilane having an alkyl group comprised of a hydrocarbon, an aliphatic hydrocarbon, or a fluorohydrocarbon of 1 to about 30 carbon atoms.

In another embodiment a hydrophobic or superhydrophobic composition is provided which includes repeating units having the structure:

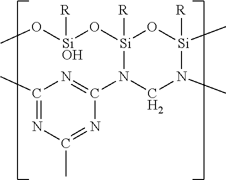

where R is an alkyl group comprised of a hydrocarbon, an aliphatic hydrocarbon, or a fluorohydrocarbon of 1 to about 30 carbon atoms.

In yet another embodiment, a method of forming a hydrophobic composition is provided. The method includes contacting at least: a substrate having a reacting group which reacts with a silane and an alkylsilane or a fluoroalkylsilane having an alkyl group comprised of an aliphatic hydrocarbon of 1 to about 30 carbon atoms;

Embodiments also include a method for collecting oil on a surface. The method includes dispensing a quantity of the hydrophobic composition described herein across the oil on the surface, whereupon the oil is absorbed into the hydrophobic composition, and collecting the hydrophobic composition.

### BRIEF DESCRIPTION OF THE DRAWINGS

FIG. 1A is a flow diagram showing the mechanism of silanization of a substrate;

FIG. 1B is a schematic illustration of the composition and structure of an untreated melamine sponge, as well as a picture of a drop of water incorporated onto the melamine sponge;

FIG. 1C is a schematic illustration of the composition and structure of a melamine sponge after silanization, as well as a drop of water on top of the sponge surface;

FIG. 2A is a plot of the ATR-FTIR data for melamine sponge before (melamine sponge) and after silanization (sMS-5, sMS-10, sMS-20, and sMS-30);

FIG. 2B is a plot of the XPS data for melamine sponge before (melamine sponge) and after silanization(sMS-10);

FIG. 2C is a plot of the TGA data for melamine sponge before (melamine sponge) and after silanization (sMS-5, sMS-10, sMS-20, and sMS-30);

FIG. 3 shows scanning electron microscope (SEM) images of (a, b) melamine sponge and (c, d) silanized melamine sponge, according to an embodiment;

FIG. 4A is a plot of the static water contact angle results on silanized materials as functions of silanization time; the inset is an optical photograph of a water droplet on a silanized melamine sponge with a silanization time of 10 minutes;

FIG. 4B is a photograph of an untreated melamine sponge and silanized melamine sponge being placed on water; the melamine sponge sinks to the bottom, while the silanized melamine sponge floats on the water;

FIG. 4C is a photograph of a silanized melamine sponge being immersed in water by applying external force;

FIG. 5 shows (a) oil dyed with Sudan III on the surface of brackish water, (b, c) selective sorption of the oil into a silanized melamine sponge (sMS-10), and (d) water without any visible signs of the oil;

FIG. 6 is a plot of sorption recyclability of a silanized melamine sponge for various kinds of organic solvents and oils.

### DETAILED DESCRIPTION

This disclosure provides embodiments of superhydrophobic compositions with superior recyclability, good mechanical strength, low cost, and manufacture scalability. This disclosure describes facile, cost effective, and scalable methods to fabricate robust, superhydrophobic compositions through the silanization of commercially available substrates.

The substrates may include any substrates that have reactive groups susceptible to silanization. The substrate may be porous, such as in foams or sponges. In certain embodiments, the substrate may be an open cell foam. Alternatively, the substrate may be a fabric of a woven or non-woven material. In certain embodiments, the substrate may be a cellulose based foam or sponge, as known in the art.

In an embodiment the substrate is a melamine foam or sponge. Such melamine foams are known in the art. For example, a melamine foam may be produced by foaming an aqueous solution of a melamine foam condensation product which may include an emulsifier, a curing agent and a blowing agent, e.g., a C4-C8 hydrocarbon and curing the melamine foam condensate at an elevated temperature. More specifically, the melamine foam may be formed from melamine-formaldehyde precondensates. Melamine-formaldehyde precondensates may, in addition to melamine, contain up to 50% by weight of other thermoset resin precursors as co-condensed units, and may, in addition to formaldehyde, contain up to 50% by weight by weight, of other aldehydes as co-condensed units. Examples of additional thermoset resin precursors which may be present are alkyl-substituted melamine, urea, urethanes, carboxylic acid amides, dicyandiamide, guanidine, sulfurylamide, sulfonic acid amides, aliphatic amines, phenol and its derivatives. Examples of other aldehydes which may be employed are acetaldehyde, trimethylolacetaldehyde, acrolein, benzaldehyde, furfuraldehyde, glyoxal, phthalaldehyde and terephthalaldehyde. The melamine resins may also contain co-condensed sulfite groups, by adding from 1 to 20% by weight of sodium bisulfite during or after the condensation of the resin.

The silanization of the substrate may be achieved by contacting the substrate with an alkylsilane. The alkyl group of the alkylsilane may be aromatic, straight or branched chain aliphatic, or a fluorohydrocarbon. The alkyl group may be substituted and may be unsaturated at one or more bonds. In certain embodiments the alkylsilanes include alkyl groups of hydrocarbons or fluorohydrocarbons of about 1 to about 30 carbon atoms. All individual values and subranges between about 1 to about 30 carbon atoms are included herein and disclosed herein; for example, the number of carbon atoms may be from a lower limit of about 1, 2, 3, 4, 5, 6, 7, 8, 9, 10, 11, 12, 13, 14, 15, 16, 17, 18, 19, 20,21, 22, 23, 24, or 25 to an upper limit of about 5, 6, 7, 8, 9, 10, 11, 12, 13, 14, 15, 16, 17, 18, 19, 20,21, 22, 23, 24, 25, 26, 27, 28, 29, or 30. In certain embodiments, the number of carbons is 18.

The alkylsilane may have a structure Rₓ—Si—(CH₃)_{y}(Z)_{4-x-y}, where R is the alkyl group as described above, and Z is selected from at least one of Br, Cl, F, an alkoxy group having from 1 to 3 carbon atoms or chlorine atoms, or a combination thereof. x is 1 or 2; y is 0, 1, or 2. In certain embodiments, the alkylsilane may include at least one of octadecyltrichlorosilane, dodecyltrichlorosilane, octyltrichlorosilane, butyltrichlorosilane, or a combination thereof.

The alkylsilane may be in a liquid or vapor phase when contacted with the substrate. The substrate may be contacted with a solution or a vapor of the alkylsilane in a suitable solvent. The concentration of the alkylsilane in the solvent may range from about 0.05 wt. % to about 100 wt. % (no solvent). All individual values and subranges between about 0.05 wt. % to about 100 wt. % are included herein and disclosed herein; for example, the concentration may be from a lower limit of about 0.05, 0.1, 0.15, 0.2, 0.3, 0.4, 0.5, 0.6, 0.7, 0.75, 0.8, 0.9, 1, 5, 10, 20, 25, 30, 35, 40, 50, 60, 70, 80, or 90 wt. % to an upper limit of about 1, 5, 10, 20, 25, 30, 35, 40, 50, 60, 70, 80, 90, 95, 96, 97, 98, 99, or 100 wt. %. In certain embodiments, the concentration is about 0.5 wt. %. The solvent may be a non-polar solvent such as pentane, cyclopentane, hexane, cyclohexane, benzene, toluene, 1,4-dioxane, chloroform, or diethyl ether. The solvent may be a polar aprotic solvent such as a dichloromethane, tetrahydrofuran, ethyl acetate, acetone, dimethylformamide, acetonitrile, dimethyl sulfoxide, or propylene carbonate, or a non-aqueous polar protic solvent such as an alcohol. In certain embodiments, the solvent is toluene.

The substrate may be contacted with the alkylsilane for about 10 seconds, to about 30 minutes or more. All individual values and subranges between about 10 seconds and about 30 minutes are included herein and disclosed herein; for example, the contact time may be from a lower limit of about 10 seconds, 30 seconds, 45 seconds, or 1, 5, 10, 20, or 25 minutes to an upper limit of about 5, 10, 20, 25, or 30, minutes or more. In certain embodiments, the contacting time is about 10 minutes.

Unreacted alkylsilane may be removed from the silanized substrate by pressing or squeezing the absorbed alkylsilane or alkylsilane solution. The silanized substrate may be repeatedly washed with solvent to remove unreacted alkylsilane. The silanized substrate may be dried at elevated temperatures. For example, the temperature may be between about 50° C. and about 200° C., such as between about 75° C. and about 150° C. In certain embodiments, the drying temperature is about 120° C. The silanized substrate may be dried until all the solvent has been removed, for example between about 0.25-12 hours, such as between about 0.5 hours and about 5 hours. In one embodiment the silanized substrate is dried for about 1 hour.

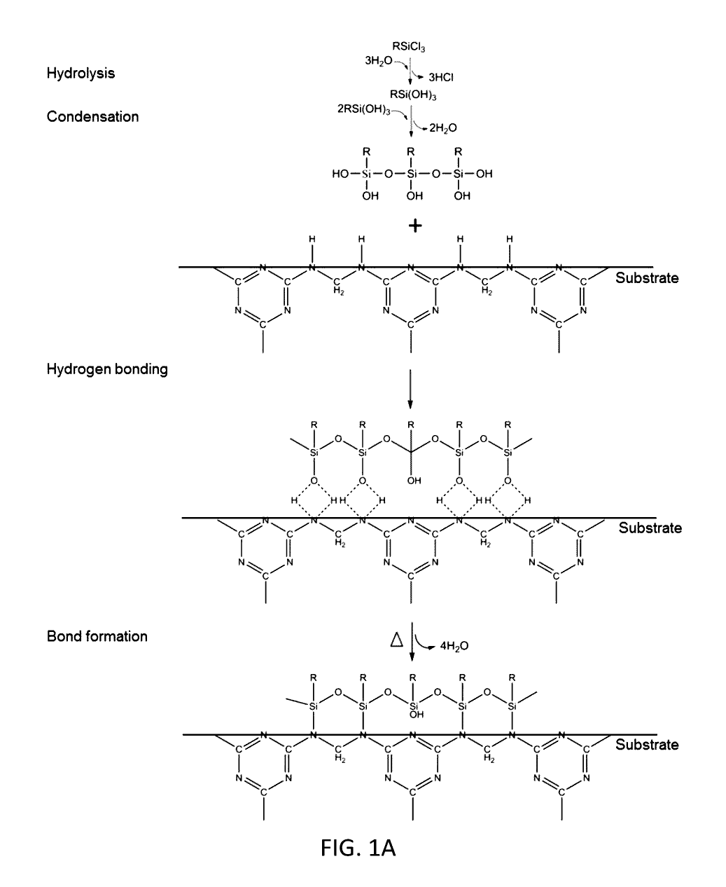

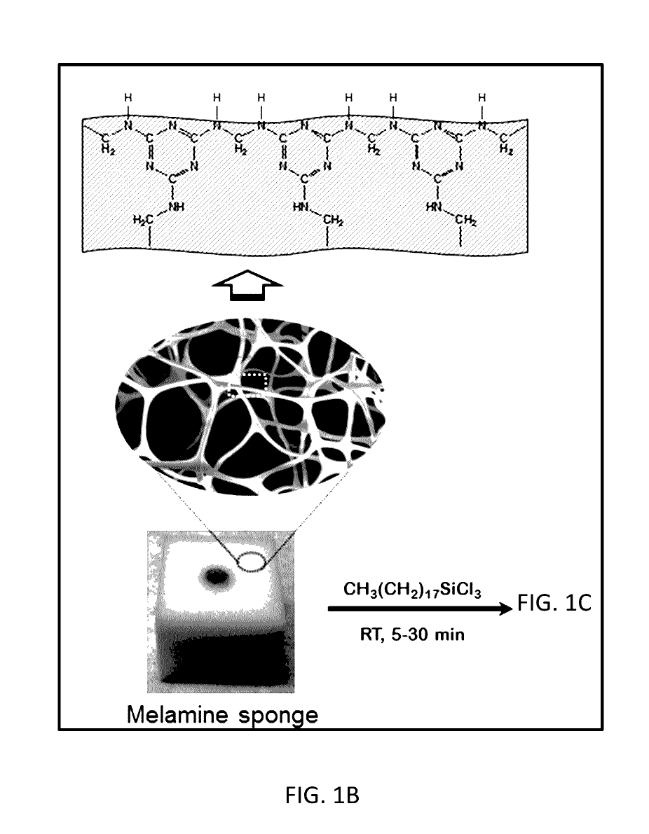

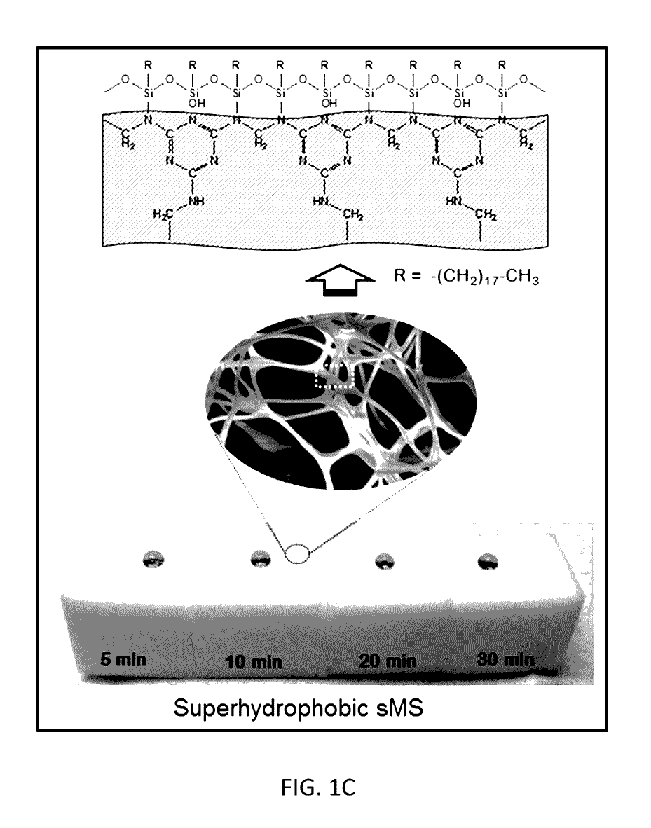

FIG. 1A shows the reaction process, in an embodiment, where the substrate is a melamine based sponge. The alkylsilane is first hydrolyzed by water that is absorbed onto the surface of the melamine sponge's skeleton (melamine sponges absorb ˜4.0 wt % of H₂O at room temperature due to its high hydrophilicity, see FIG. 1B where a drop of colored water is absorbed into the sponge) to form silanol compounds. Subsequently, two reactions simultaneously occur: i) direct hydrogen bonding between the silanol and the secondary amine groups (SAM) on the melamine sponge skeleton's surface; and ii) condensation of the Si—OH to form oligomers, which further interact with amine groups via hydrogen bonding. Finally during the drying step, dehydration reactions occurred that resulted in the SAM covalently bonding onto the surface of the skeletons. Thus, through the reaction of secondary amine groups on the surface of the sponge skeletons with alkylsilane compounds, self-assembled monolayers on the surface of sponge skeletons are formed. This results in an ability to tune the surface properties of the substrates from hydrophilicity to superhydrophobicity (see FIG. 1C, where the water droplet is on top of the sponge surface, and not absorbed by the sponge).

The silanized substrates may exhibit water contact angles of above 145°, such as at least 147°, 149°, 150°, or 151°. The silanized substrates may exhibit excellent sorption capacities greater than 80 times its own weight, such as at least 82, 84, 90, 94, 96, 99, 99, 100, 110, 115, 120, 130, 140, 150, 160 or 163 times its own weight. The silanized substrate sorption capacity may be for any suitable organic solvent, for example for at least one of acetone, butanol, toluene, tetrahydrofuran, dimethylformamide, chloroform, diesel, motor oil, machine oil, biodiesel, mineral oil, or combinations thereof. The silanized substrates may also exhibit high selectivity and outstanding recyclability with an absorption capacity retention of more than 90% after 1000 cycles.

The superhydrophobic properties of the silanized substrates make the silanized substrates very suitable for oil (or other organic solvent) spill cleanup. The silanized substrates may be dispersed over a surface (such as water or sea shore) that contains the spilled oil (or solvent). The silanized substrates will then soak up the oil (or solvents), and upon collecting the silanized substrates, they can be mechanically pressed or squeezed so that most of the oil (or solvent) is reclaimed. Through this process, the silanized substrates may then repeatedly be dispersed over the spilled oil (or solvent) until the spill is cleaned up. This may be repeated for example, about 100 to about 1000 cycles. After a pickup job is completed, the silanized substrates may be stored for further use.

### EXAMPLES

Materials: Commercial melamine sponges were purchased from spongeoutlet.com. The melamine sponges have a bulk density of 8.07 mg cm⁻³, which accounts for a 99.49% porosity considering a specific density of 1.57 g cm⁻³ for melamine resin. Octadecyltrichlorosilane and organic solvents (acetone, butanol, toluene, tetrahydrofuran (THF), dimethylformamide (DMF), and chloroform) were purchased from Sigma Aldrich. Oils (motor oil, machine oil, and mineral oil) were obtained from McMaster-Carr. The diesel and biodiesel were obtained from the Sustainable Energy Technologies Department at Brookhaven National Laboratory.

Silanization of melamine sponge: Melamine sponges were cut into 2.5×2.5×3.0 cm³ pieces and then immersed into a solution of octadecyltrichlorosilane in toluene (0.5 wt. %) for 5, 10, 20 or 30 min. Subsequently, the sponges were removed from the solution and were squeezed to extract the absorbed solution. The sponges were repeatedly washed with fresh toluene by a sorption-squeezing process and were finally dried at 120° C. for 1 h. The resultant silanized melamine sponges were denoted as sMS-x, where x indicates the silanization time in minutes.

Characterization of sMS-x sponges: The sMS-x sponges were characterized by attenuated total reflection-Fourier transform infrared spectroscopy (ATR-FTIR, Thermo Scientific). The elemental compositions of the surfaces of the sponges were determined by X-ray photoelectron spectroscopy (XPS). The morphologies of melamine sponges were observed by scanning electron microscopy (SEM, Hitachi S4800). Contact angle measurements were carried out using an OCA 15+ goniometer (DataPhysics). Thermogravimetric analysis (TGA) was performed on under a nitrogen atmosphere at a heating rate of 10° C./min (PerkinElmer).

Oil sorption and recyclability of sMS-x sponges: The absorption capacities of the sMS-x sponges for various oils and organic solvents were determined by dipping a piece of sMS-x sponges in oils or organic solvents until the sMS was saturated with oils or organic solvents, and then taking the sponge out for weight measurement. The gravimetric sorption capacity (Q_{m/m}), gravimetric/volumetric sorption capacity (Q_{m/v}) and volumetric sorption capacity (Q_{v/v}) were calculated according to the equations:

$$\begin{matrix}{Q}_{m / m} = \frac{( {m}_{S , O} - {m}_{S} )}{{m}_{S}} & ( 1 ) \\ {Q}_{m / v} = {Q}_{m / m} * {d}_{S} = \frac{( {m}_{S , O} - {m}_{S} )}{{m}_{S}} {d}_{S} & ( 2 ) \\ {Q}_{v / v} = \frac{{Q}_{m / v}}{{d}_{O}} = \frac{( {m}_{S , O} - {m}_{S} )}{{m}_{S}} \frac{{d}_{S}}{{d}_{O}} & ( 3 )\end{matrix}$$

where m_{S} and m_{S,O} are the sponge's weights before and after sorption, respectively, d_{S} and d_{O} are the bulk density of the sponge and the density of organic liquid, respectively.

The recyclability of the sMS-x sponges was evaluated by repeated sorption-squeezing processes. The sorption-squeezing was performed by immersing the sMS-x sponges into oils, waiting until the sponge became saturated with the oils, and then manually squeezing the sponge using a clamp to extract at least 80% of absorbed oils.

Silanization efficiency: The silanization efficiency was characterized by gravimetric measurements using an analytical balance with an accuracy of 0.01 mg. Table 1 shows that the alkylsilane loading on sMS-x was very small, less than 0.6 wt %. The silanization occurred quickly during the first 10 min and approached saturation after 30 min. The bulk density of the sMS slightly increased as a function of silanization time, from 8.07 mg cm⁻³ for the untreated melamine sponge to 8.12 mg cm⁻³ for the sMS-30 sample. The porosities of the untreated melamine sponge and the sMSs sponges were nearly identical.

TABLE 1
Properties of melamine sponge and sMS-x sponges

| | Alkylsilane loading | Bulk density | Porosity |
|---|---|---|---|
| | on sMS (wt %) | (mg/cm³) | (%) |
| Melamine sponge | — | 8.07 | 99.49 |
| sMS-5 | 0.338 | 8.10 | 99.48 |
| sMS-10 | 0.507 | 8.11 | 99.48 |
| sMS-20 | 0.572 | 8.11 | 99.48 |
| sMS-30 | 0.588 | 8.12 | 99.48 |

Upon the melamine sponges being dipped into octadecyltrichlorosilane solution, the octadecyltrichlorosilane was first hydrolyzed by water that had absorbed onto the surface of the melamine sponge's skeleton (melamine sponges absorb ˜4.0 wt % of H₂O at room temperature due to its high hydrophilicity) to form silanol compounds. Subsequently, two reactions simultaneously occurred: i) direct hydrogen bonding between the silanol and the secondary amine groups (SAM) on the of melamine sponge skeleton's surface; and ii) condensation of the Si—OH to form oligomers, which further interact with amine groups via hydrogen bonding. Finally during the drying step, dehydration reactions occurred that resulted in the SAM covalently bonding onto the surface of the skeletons (FIG. 1A).

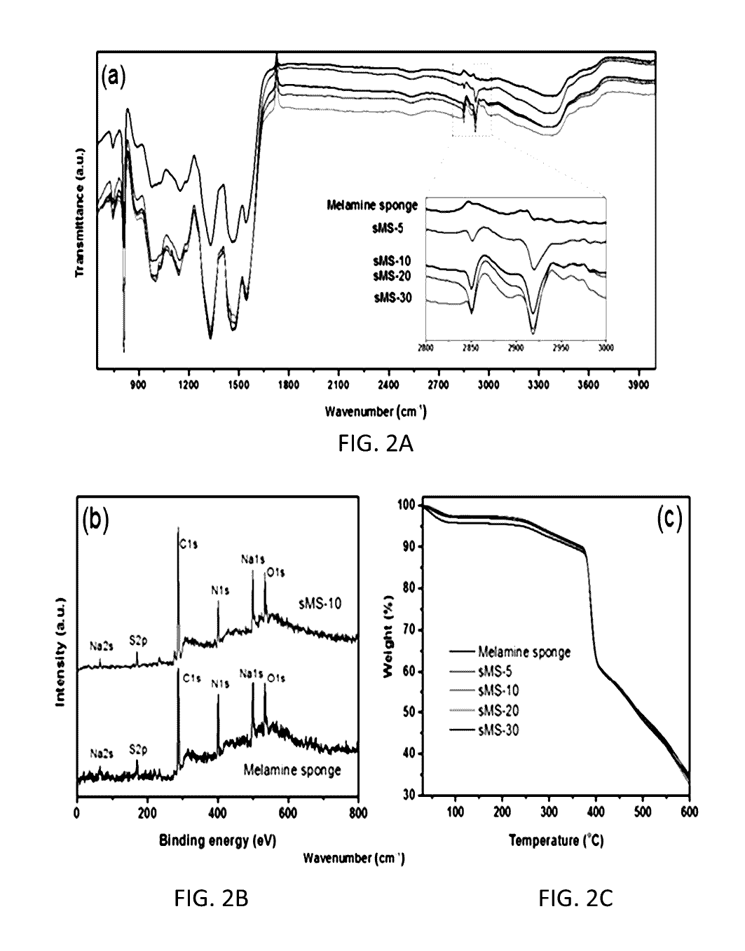

Sponge characterization: The formation of the alkylsilane SAM on the sponge skeletons was characterized by ATR-FTIR, XPS, and TGA. FIG. 2A shows the ATR-FTIR spectra of the untreated melamine sponge and the sMS as functions of silanization time. The spectrum of the melamine sponge displayed prominent peaks at 812, 1143, 1542 and 3394 cm⁻¹ that were assigned to triazine ring bending, C—O stretching, C═N stretching, and N—H (of secondary amine) stretching, respectively. Peaks centered at 981, 1328 and 1467 cm⁻¹ were indicative of C—H bending. Moreover, two small peaks at 2827 and 2891 cm⁻¹ were attributed to C—H stretching. After silanization, the intensity of these peaks strengthened significantly and slightly red-shifted to 2850 and 2920 cm⁻¹, which were ascribed to C—H stretching in the —CH₂ and —CH₃ of the alkylsilane. In addition, the intensity of the peak centered at 990 cm⁻¹ significantly increased due to the overlapping of the C—H bending peak (981 cm⁻¹) and a new Si—O—Si stretching peak (1004 cm⁻¹) that evolved due to the formation of alkylsilane SAM on the surface of sMS's skeleton.

XPS was employed further to confirm the silanization of the melamine sponges. The XPS survey spectrum in FIG. 2B indicates five elements, including C, N, O, Na, and S. This is consistent with the composition of commercial foams containing the formaldehyde-melamine-sodium bisulfite copolymer. Although no difference was observed in the binding energies of the element peaks after silanization, the intensity of C1s significantly increased indicating the functionalization of alkylsilane on surface of sMS's skeleton. The absence of a Si peak in the spectra of sMS might be explained by the low absolute concentration of Si within the system, below the detection limit.

FIG. 2C shows TGA curves of the melamine sponge and sMSs characterized in an argon atmosphere. The TGA curve of the melamine sponge can be defined into four temperature ranges through which the mass losses appeared, from 30 to 100° C., 230 to 370° C., 370 to 405° C., and 405 to 600° C., respectively. The mass loss of ˜4.0 wt % in the first temperature region of 30-100° C. can be attributed to the evaporation of the absorbed water on the hydrophilic surface of the sponge. The main mass loss of ˜27.0 wt % that occurred in the temperature region of 370-405° C. can be ascribed to the breakdown of the methylene bridges. Losses at temperatures higher than 405° C. were attributed to the thermal decomposition of the triazine ring. The TGA curves of sMSs were almost identical and were similar to the TGA curve of the untreated melamine sponge. Though, two small differences were evident: i) the mass loss in the first temperature region was only ˜2.5 wt % due to a smaller amount of water absorbed onto the hydrophobic surface of sMSs; and ii) the primary mass loss in the temperature region of 370-405° C. was somewhat larger, ˜28.0 wt %, due to the thermal decomposition of the alkylsilane SAM.

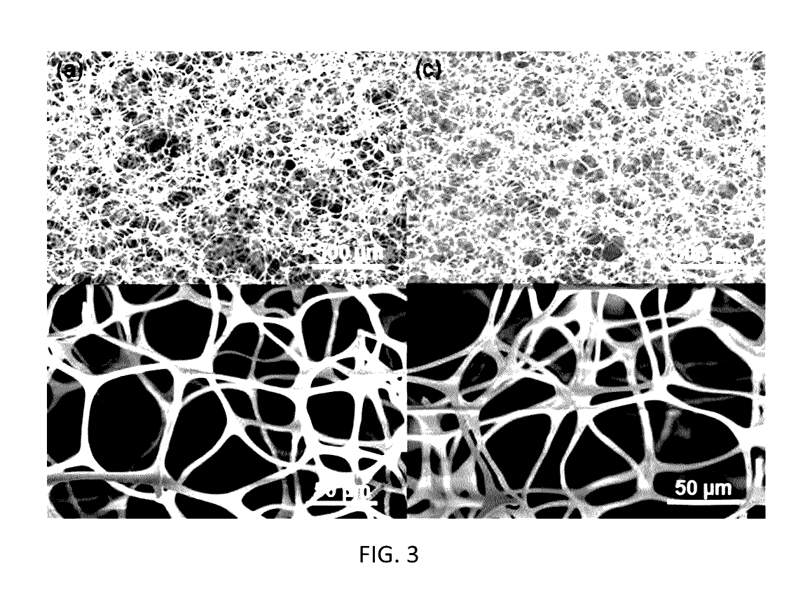

The morphologies of the melamine sponges before and after silanization were examined by SEM, as shown in FIG. 3 (untreated melamine sponge (a, b) and sMS-10 (c, d)). The melamine sponges are three-dimensional, hierarchical, porous structures with pore sizes in the range of 100-150 μm and with smooth skeletons of average diameter ˜10 μm. As expected, the sMS materials had the same porous structure and skeleton dimensions, reaffirming that the thickness of alkylsilane SAM (˜3.0 nm) on surface of the skeleton was well within the uncertainty of the skeleton's thickness (˜10.0 μm).

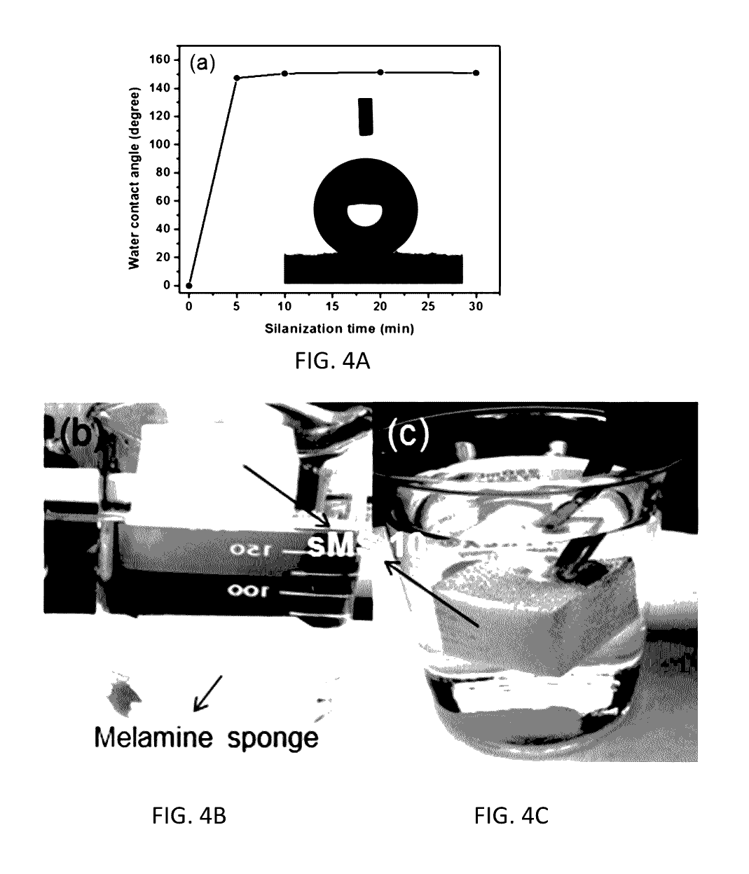

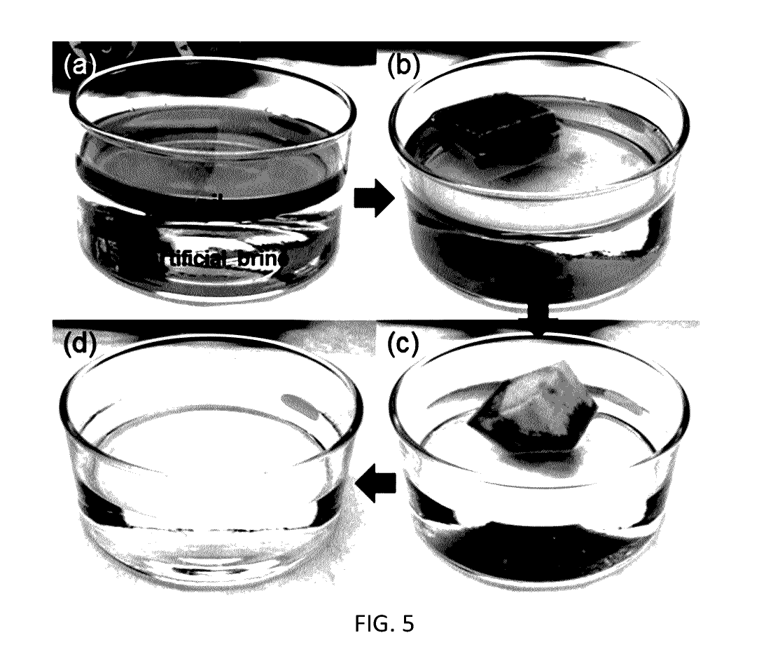

Hydrophobicity: The hydrophobicity of the sMS materials was characterized by water contact angle measurements. As shown in FIG. 4A, the water contact angle of sMS notably increased as a function of silanization time, from 0° for the melamine sponge to 147.2° after 5 min of silanization. After 10 min, the value reached 150.4° and a maximum of 151° after 30 min, indicating the superhydrophobic characteristics of the functionalized sponges. FIG. 4B depicts a photograph of the superhydrophobic sMS-10 floated atop a water bath while the hydrophilic melamine sponge sank to the bottom. When immersing the superhydrophobic sMS-10 in water by applying an external force (FIG. 4C), an interface formed between entrapped air residing along the surface of the sponge and the surrounding water, giving rise to a mirror-like surface on the sMS-10; this phenomenon is due to the Cassie-Baxter non-wetting behavior. After the external force was released, the sMS-10 immediately floated to the water surface without absorption of any of the surrounding water, indicating its excellent water repellency.

Selective sorption: FIG. 5 shows the selective sorption of oil (dyed with Sudan III) on the surface of brackish water (a) exhibited by sMS-10. By dipping the sMS-10 into a mixture of oil and water (b), the oil was quickly absorbed into sponge in a few seconds (c). As seen in (5b), the oil-saturated sMS-10 continued to float on the water surface; removal of the oil, thus, involved removing the sMS-10 from the environment. The absorbed oil was easily recaptured by the aforementioned squeezing process. Then, the processed sMS-10 was reestablished at the oil-water interface to remove the remaining oil from the water surface, resulting in water without any visible signs of the oil (5d).

Maximum sorption capacity: To investigate the maximum sorption capacity, sorption tests were performed in organic solvents and oils in the absence of water. Various organic solvents and oils with different polarities, densities, and viscosities were tested. The sorption uptake rate of the sMS strongly depended on the viscosity of the organic solvents and oils, ranging from a few seconds for low viscosity organic solvents, such as toluene, THF, DMF, and chloroform, to minutes for high viscosity oils, such as diesel, mineral oil, and machine oil. Table 2 shows the sorption capacities and its retention after 100 cycles of sorption-squeezing of sMS-10 for various kinds of organic solvents and oils. The sMS-10 exhibited very high sorption capacity, from 82 to 163 times its own weight, depending on the polarity and density of the employed organic solvents and oils. More interestingly, the sMS-10 also showed excellent recyclability with sorption capacity retention after 100 cycles of sorption-squeezing more than 93% for all kinds of organic solvents and oils.

TABLE 2
Sorption capacities and sorption capacity retentions
after 100 cycles of sorption-squeezing of sMS-10
for various organic solvents and oils.

| | | | Sorption | Sorption capacity |
|---|---|---|---|---|
| | Density | Sorption | capacity | retention after |
| | (g/cm³) | capacity (g/g) | (kg/m³) | 100 cycles (%) |
| Acetone | 0.79 | 83.6 | 685.5 | 96.1 |
| Butanol | 0.81 | 82.0 | 672.4 | 97.4 |
| Toluene | 0.87 | 96.2 | 788.8 | 98.6 |
| THF | 0.89 | 91.1 | 747.0 | 96.1 |
| DMF | 0.94 | 97.4 | 798.7 | 98.7 |
| Chloroform | 1.48 | 163.0 | 1336.8 | 94.6 |
| Diesel | 0.83 | 93.6 | 767.5 | 93.4 |
| Motor oil | 0.86 | 94.0 | 770.8 | 95.5 |
| Machine oil | 0.86 | 99.8 | 818.4 | 96.4 |
| Biodiesel | 0.88 | 98.2 | 805.2 | 94.0 |
| Mineral oil | 0.88 | 100.7 | 825.7 | 96.9 |

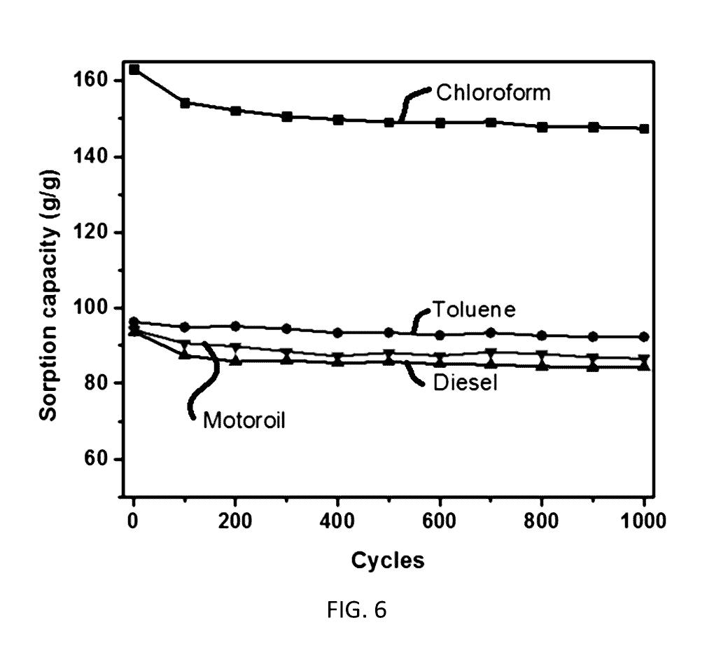

For further analysis of the recyclability of sMS-10, four kinds of organic solvents and oils, including toluene, chloroform, diesel and motor oil, were chosen to be tested up to 1000 cycles of sorption-squeezing at a strain compression of 80%. As shown in FIG. 6, the sorption capacity retention of sMS-10 for all of the chosen organic solvents and oils remained higher than 90%, indicating the outstanding recyclability of sMS-10. sMS-10 may be the first sponge or sponge-like sorbent material that possesses a demonstrated sorption-squeezing recyclability capacity greater than 90% for cycling up to 1000 cycles for a variety of organic solvents and oils.

Table 3 juxtaposes the properties of sMS with other sponge and sponge-like sorbent materials of other studies. For the majority of the studies of oil absorbent materials, the gravimetric sorption capacity was used to evaluate the overall absorption ability of said materials. The gravimetric sorption capacity density depends on the bulk density, more than on the porosity of the sorbent material. Therefore, the sorbent materials that have low or ultra-low bulk densities typically exhibit high gravimetric sorption capacities. However, their volumetric sorption capacity sometimes can be lower than that of other sorbent materials that have low gravimetric sorption capacity. For example, as shown in Table 3, graphene—CNT aerogel has a gravimetric sorption capacity for chloroform of up to 568 g/g and a volumetric sorption capacity of only 0.537 m³/m³, which is significantly lower than that of marshmallow-like macroporous gel (gravimetric sorption capacity=14 g/g). For practical applications, use of the volumetric sorption capacity and the gravimetric/volumetric sorption capacity, instead of gravimetric sorption capacity, are notably more reasonable and are more appropriate figures-of-merit. For example, although the marshmallow-like macroporous gel reference reports a gravimetric sorption capacity of 14 g/g, the study's data subsequently led to a volumetric sorption capacity of 1.135 m³/m³, which is unphysical. In other words, the report suggests that this macroporous gel can retain a larger volume of chloroform than the rectilinear, perimeter volume subtended by the gel itself (by a factor of 1.135). Not only does the sMS materials described herein possess high sorption capacities that are comparable to the best sorbent materials, the sMS also exhibits markedly enhanced recyclability by the sorption-squeezing process, compared with the other sorbent materials. Moreover, the fabrication of sMS is fast, simple, cost effective and easily scalable. More significantly, the sMS materials provide comparable, if not superior, oil sorption characteristics, making them promising materials for oil spill remediation applications.

TABLE 3
Comparison of sponge and sponge-like sorbent materials

| | | Sorption | Sorption | Sorption | Recyclability by | | |
|---|---|---|---|---|---|---|---|
| | | capacity | capacity | capacity | sorption- | | |
| Sorbent materials | Solvent/oil | (g/g) | (kg/m) | (m³/m³) | squeezing process | Cost | Ref.* |
| Marshmallow-like | Chloroform | 14 | 1680 | 1.135 | Not reported | medium | 1 |
| macroporous gel | Mineral oil | 8 | 960 | 1.090 | | | |
| Carbon fiber aerogel | Chloroform | 115 | 1380 | 0.932 | Fair | quite | 2 |
| | Olive oil | 85 | 1020 | 1.133 | | low | |
| CNT sponge | Chloroform | 176 | 1038 | 0.701 | Excellent | high | 3 |
| | Diesel | 144 | 849 | 0.998 | | | |
| Graphene framework | Chloroform | 490 | 1029 | 0.695 | Poor | high | 4 |
| | Olive oil | 480 | 1008 | 1.095 | | | |
| Graphene - CNT | Chloroform | 568 | 795 | 0.537 | Excellent | high | 5 |
| aerogel | Motor oil | 341 | 477 | 0.542 | | | |
| Graphene coated | Chloroform | 165 | 1864 | 1.259 | Poor | medium | 6 |
| melamine sponge | Pump oil | 92 | 1040 | 1.155 | | | |
| Reduced graphene | Chloroform | 160 | 1408 | 0.951 | Good | medium | 7 |
| oxide coated | Pump oil | 100 | 880 | 0.978 | | | |
| polyurethane sponge | | | | | | | |
| sMS-10 | Chloroform | 163 | 1337 | 0.903 | Outstanding | low | Present |
| | Mineral oil | 101 | 862 | 0.938 | | | work |

*References:
1) G. Hayase, K. Kanamori, M. Fukuchi, H. Kaji, K. Nakanishi, Facile synthesis of marshmallow-like macroporous gels usable under harsh condition for the separation of oil and water, Angew. Chem. Int. Ed. 2013, 52, 1986-1989.
2) H. Bi, Z. Yin, X. Cao, X. Xie, C. Tan, X. Huang, B. Chen, F. Chen, Q. Yang, X. Bu, X. Lu, L. Sun, H. Zhang, Carbon fiber aerogel made from raw cotton: A novel, efficient and recyclable sorbent for oils and organic solvents, Adv. Mater. 2013, 25, 5916-5921.
3) X. Gui, J. Wei, K. Wang, A. Cao, H. Zhu, Y. Jia, Q. Shu, D. Wu, Carbon nanotube sponge, Adv. Mater. 2010, 22, 617-621.
4) Y. Zhao, C. Hu, Y. Hu, H. Cheng, G. Shi, L. Qu, A versatile, ultralight, nitrogen-doped graphene framework, Angew. Chem. Int. Ed. 2012, 51, 11371-11375.
5) H. Sun, Z. Xu, C. Gao, Multifunctional, ultra-flyweight, synergistically assembled carbon aerogels, Adv. Mater. 2013, 25, 2554-2560.
6) D. D. Nguyen, N.-H. Tai, S.-B. Lee, W.-S. Kuo, Superhydrophobic and superoleophilic properties of graphene-based sponges fabricated using a facile dip coating method, Energy Environ. Sci. 2012, 5, 7908-7912.
7) Y. Liu, J. Ma, T. Wu, X. Wang, G. Huang, Y. Liu, H. Qiu, Y. Li, W. Wang, J. Gao, Cost-effective reduced graphene oxide-coated polyurethane sponge as a highly efficient and reusable oil-absorbent, ACS Appl. Mater. Interfaces 2013, 5, 10018-10026.

The description has not attempted to exhaustively enumerate all possible variations. The alternate embodiments may not have been presented for a specific portion of the invention, and may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent. Furthermore, all references, publications, U.S. Patents, and U.S. Patent Application Publications cited throughout this specification are incorporated by reference as if fully set forth in this specification.

1. A hydrophobic composition, comprising the reaction product of at least:
a substrate having a reacting group which reacts with a silane; and
an alkylsilane having an alkyl group comprised of a hydrocarbon, an aliphatic hydrocarbon, or a fluorohydrocarbon of 1 to about 30 carbon atoms.

2. The hydrophobic composition of claim 1, wherein the alkylsilane has a structure Rₓ—Si—(CH₃)_{y}(Z)_{4-x-y}, where R is the alkyl group comprised of a hydrocarbon, an aliphatic hydrocarbon, or a fluorohydrocarbon of 1 to about 30 carbon atoms, Z is selected from at least one of Br, Cl, F, an alkoxy group having from 1 to 3 carbon atoms or chlorine atoms, or a combination thereof, x is 1 or 2, and y is 0, 1, or 2.

3. The hydrophobic composition of claim 2, wherein the alkylsilane is an alkyltrichlorosilane,

4. The hydrophobic composition of claim 3, wherein the alkyl group comprises a hydrocarbon, an aliphatic hydrocarbon, or a fluorohydrocarbon of from about 12 to about 20 carbons.

5. The hydrophobic composition of claim 1, wherein the alkylsilane comprises at least one of octadecyltrichlorosilane, dodecyltrichlorosilane, octyltrichlorosilane, butyltrichlorosilane.

6. The hydrophobic composition of claim 1, wherein the substrate comprises an open cell foam or a fabric.

7. The hydrophobic composition of claim 6, wherein the open cell foam comprises a melamine based foam.

8. The hydrophobic composition of claim 7, wherein the melamine foam is formed from melamine-formaldehyde pre-condensates.

9. The hydrophobic composition of claim 1, wherein the substrate comprises cellulose.

10. The hydrophobic composition of claim 1, wherein the substrate comprises a cellulose sponge.

11. A hydrophobic composition, comprising repeating units having the structure: 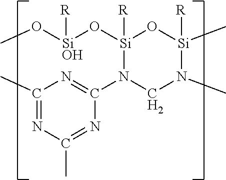
wherein R is an alkyl group comprised comprises a hydrocarbon, an aliphatic hydrocarbon, or a fluorohydrocarbon of about 1 to about 30 carbons.

12. The hydrophobic composition of claim 11, wherein R is an alkyl group comprised of a hydrocarbon, an aliphatic hydrocarbon, or a fluorohydrocarbon of about 12 to about 20 carbons.

13. The hydrophobic composition of claim 11, wherein R comprises at least one of an octadecyl, dodecyl, octyl, and butyl group.

14. The hydrophobic composition of claim 1 or 11, wherein the hydrophobic composition has after 1000 cycles a sorption capacity retention of at least 90% of original sorption capacity.

15. The hydrophobic composition of claim 1 or 11, wherein the hydrophobic composition has a sorption capacity of at least 100 times its own weight.

16. The hydrophobic composition of claim 15, wherein the sorption capacity is at least 160 times its own weight.

17. The hydrophobic composition of claim 1 or 11, wherein the hydrophobic composition exhibits a water contact angle of above 147°.

18. The hydrophobic composition of claim 17 wherein the hydrophobic composition exhibits a water contact angle of above 151°.

19. The hydrophobic composition of claim 15, wherein the sorption capacity is for the sorption of at least one of acetone, butanol, toluene, tetrahydrofuran, dimethylformamide, chloroform, diesel, motor oil, machine oil, biodiesel, mineral oil, or combinations thereof.

20. A method of forming a hydrophobic composition, the method comprising contacting at least:
a substrate having a reacting group which reacts with a silane; and
an alkylsilane having an alkyl group comprised of an aliphatic hydrocarbon of 1 to about 30 carbon atoms;

21. The method of claim 20, further comprising heating the substrate to between about 25° C. and about 200° C.

22. The method of claim 20, wherein the substrate is contacted with a liquid comprising the alkylsilane.

23. The method of claim 20, wherein the alkylsilane is dissolved in at least one of a nonpolar or a non-aqueous polar aprotic solvent.

24. The method of claim 20, wherein the substrate is contacted with a vapor phase comprising the alkylsilane.

25. The method of claim 20, wherein the alkylsilane has a structure Rₓ—Si—(CH₃)_{y}(Z)_{4-x-y}, where R is the alkyl group comprised of the aliphatic hydrocarbon of 1 to about 30 carbon atoms, Z is selected from at least one of Br, Cl, F, an alkoxy group having from 1 to 3 carbon atoms or chlorine atoms, or a combination thereof, x is 1 or 2, and y is 0, 1, or 2.

26. The method of claim 20, wherein the alkylsilane is an alkyltrichlorosilane,

27. The method of claim 20, wherein the alkyl group comprises a hydrocarbon, an aliphatic hydrocarbon, or a fluorohydrocarbon of from about 12 to about 20 carbons.

28. The method of claim 20, wherein the alkylsilane comprises at least one of octadecyltrichlorosilane, dodecyltrichlorosilane, octyltrichlorosilane, butyltrichlorosilane.

29. The method of claim 14, wherein the substrate comprises an open cell foam or a fabric.

30. A method for collecting oil on a surface, comprising dispensing a quantity of the hydrophobic composition of claim 11 across the oil on the surface;
whereupon the oil is absorbed into the hydrophobic composition; and
collecting the hydrophobic composition.

31. The method of claim 30, further comprising mechanically separating and collecting a majority of the oil from the hydrophobic composition.

32. The method of claim 31, further comprising re-dispensing the hydrophobic composition.
